(19) United States
(12) Patent Application Publication
(10) Pub. No.: US 2016/0078802 A1
(43) Pub. Date: Mar. 17, 2016

(54) LED DISPLAY CONTROL METHOD AND CONTROL CARD, LED DISPLAY SCREEN SYSTEM

(71) Applicant: Xi'an NovaStar Tech Co., Ltd., Xi'an (CN)

(72) Inventors: WEI LIANG, XI'AN (CN); HUORONG WANG, XI'AN (CN)

(21) Appl. No.: 14/948,362

(22) Filed: Nov. 22, 2015

Related U.S. Application Data
(63) Continuation of application No. PCT/CN2015/070714, filed on Jan. 14, 2015.

(30) Foreign Application Priority Data
Sep. 15, 2014 (CN) 201410468310.6

(51) Int. Cl. G09G 3/32

(52) U.S. Cl. CPC G09G 3/32; G09G 2310/0283; G09G 2320/0257

(57) ABSTRACT

The invention relates to a LED display control method adapted for being applied to multiple LEDs electrically connected to N numbers of scan lines. The method includes steps of: during a first round of scanning, receiving a row selection signal and decoding the received row selection signal to sequentially scan the N numbers of scan lines as per a first scanning order and thereby drive and control the LEDs; and during a second round of scanning, receiving another row selection signal and decoding the received another row selection signal to sequentially scan the N numbers of scan lines as per a second scanning order and thereby drive and control the LEDs. The first and second round of scannings are alternately performed, the first and second scanning orders are mutually reverse orders. The invention further provides a LED display screen system and a LED display control card.

### FIELD OF THE INVENTION

The invention relates to the field of LED display control technology, and more particularly to a LED display control method, a LED display screen system and a LED display control card.

### BACKGROUND OF THE INVENTION

FIG. 1 is a schematic partial circuit diagram of a LED (i.e., light-emitting diode) display board of a conventional scanning-type LED display screen. As illustrated in FIG. 1, the LED display board includes n×m numbers of LEDs arranged in rows and columns, a row selection signal decoder and a driver chip. The LEDs are electrically connected to row lines L1, . . . , Ln and column lines C1, . . . , Cn and located at intersected positions thereof. Positive electrodes of a same row of LEDs are electrically connected to an output terminal of a corresponding P-Channel MOSFET which is controlled by the row selection signal decoder via a same row line e.g., Ln, negative electrodes of a same column of LEDs are electrically connected to a same pin of the driver chip by a same column line e.g., Cn, and the row lines each form a parasitic capacitor with respect to the ground potential.

A conventional control system of a LED display screen system generally uses a sequential scanning method, in particular, for a LED display screen with a n-line scanning mode (i.e., n numbers of row lines), a conventional method is firstly performing the 1st line scan, then the 2nd line scan, and so on until the last line scan (i.e., nth line scan), and afterwards performing the 1st line scan to the nth line scan in that order again, and so repeatedly, the detailed process can refer to the illustration of FIG. 2.

During a current line scan which has one or more LEDs required to be lit up, since the row lines of the scanning-type LED display screen each have the parasitic capacitor with respect to the ground potential, charges stored in the parasitic capacitor of row line corresponding to the previous line scan still can drive the LED(s) which are corresponding to the previous line scan and share a same column line(s) with the LEDs required to be lit up during the current line scan to be slightly lit up, such phenomenon is called as ghost-lighting phenomenon. As per the above-described scanning method of the conventional control system, the ghost-lighting corresponding to the 2nd line scan occurs at the position of the 1st line scan, the ghost-lighting corresponding to the 3rd line scan occurs at the position of the 2nd line scan, and so on, because the last line scan (i.e., nth line scan) is the previous line scan of the 1st line scan, the ghost-lighting corresponding to the 1st line scan occurs at the position of the nth line scan; the position of nth line scan is far away from the position of the 1st line scan and thus the ghost-lighting occurred at the position of the nth line scan looks abrupt, in such way, for a displayed image with black background, ghost-lighting points far away from a normally lit up area would be easily observed in the black background area and thereby affect the viewing experience, these points are called as isolated ghost-lighting points. FIG. 3 shows such phenomenon by taking a display unit with a 8-line scanning mode. In detail, small blocks marked by the uppercase letters A-H, M-P, R-W represent points required to be lit up normally, hatched small blocks marked by the lowercase letters a-h, m-p, r-w represent ghost-lighting points, and the points a, m, n, o, p are isolated ghost-lighting points.

Therefore, it is needed to settle the above-mentioned isolated ghost-lighting points, so as to improve the user's viewing experience.

### SUMMARY OF THE INVENTION

Accordingly, in order to overcome the technical drawbacks in the prior art, an embodiment of the invention provides a LED display control method adapted for being applied to a plurality of LEDs electrically connected to N numbers of scan lines, where N is a positive integer greater than 1. In particular, the LED display control method includes steps of: during a first round of scanning, receiving a row selection signal and decoding the received row selection signal to sequentially scan the N numbers of scan lines as per a first scanning order and thereby drive and control the plurality of LEDs; and during a second round of scanning, receiving another row selection signal and decoding the received another row selection signal to sequentially scan the N numbers of scan lines as per a second scanning order and thereby drive and control the plurality of LEDs. The first round of scanning and the second round of scanning are alternately performed, the first scanning order and the second scanning order are mutually reverse orders.

In an embodiment of the invention, the above row selection signals each are a multi-bit digital signal.

In an embodiment of the invention, the digital signal is a 2-bit digital signal, a 3-bit digital signal or a 4-bit digital signal; and correspondingly, a value of N is 4, 8 or 16.

Moreover, an embodiment of the invention provides a LED display screen system including a LED display control card and a LED display board electrically connected with the LED display control card. The LED display board is disposed with a decoder and multiple LEDs electrically connected to N numbers of scan lines, where N is a positive integer greater than 1. The LED display control card is disposed with a forward and reverse alternate scanning driving module. The forward and reverse alternate scanning driving module is configured (i.e., structured and arranged) for: during a first round of scanning, generating a row selection signal to the decoder and thereby the decoder decoding the received row selection signal to sequentially scan the N numbers of scan lines as per a first scanning order so as to drive and control the LEDs; and during a second round of scanning, generating another row selection signal to the decoder and thereby the decoder decoding the received another selection signal to sequentially scan the N numbers of scan lines as per a second scanning order so as to drive and control the LEDs. The first round of scanning and the second round of scanning are alternately performed, the first scanning order and the second scanning order are mutually reverse orders.

In an embodiment of the invention, the above row selection signals associated with the LED display screen system each are a multi-bit digital signal.

In an embodiment of the invention, the LED display control card is disposed with a programmable logic device; the forward and reverse alternate scanning driving module and the programmable logic device are integrated into a same chip.

In addition, an embodiment of the invention provides a LED display control card adapted for receiving an image signal and processing the received image signal to thereby drive and control the LED display board. The LED display board is disposed with multiple LEDs electrically connected to N numbers of scan lines, where N is a positive integer greater than 1. The LED display control card further is disposed with a forward and reverse alternate scanning driving module. The forward and reverse alternate scanning driving module is configured (i.e., structured and arranged) for: during a first round of scanning, generating a row selection signal to the LED display board to thereby control the LED display board to sequentially scan the N numbers of scan lines as per a first scanning order so as to drive and control the multiple LEDs; and during a second round of scanning, generating another row selection signal to the LED display board to thereby control the LED display board to sequentially scan the N numbers of scan lines as per a second scanning order so as to drive and control the multiple LEDs. The first round of scanning and the second round of scanning are alternately performed, the first scanning order and the second scanning order are mutually reverse orders.

In an embodiment of the invention, the row selection signals generated by the LED display control card each are a multi-bit digital signal.

In an embodiment of the invention, the LED display control card is a receiving card or an asynchronous control card.

In an embodiment of the invention, the LED display control card further is disposed with a programmable logic device e.g., FPGA, the forward and reverse alternate scanning driving module and the programmable logic device are integrated into a same chip.

As seen from the foregoing, the invention proposes a forward and reverse alternate scanning method, which can make that ghost-lighting points are distributed at positions of the previous line scan and the latter line scan of LEDs required to be normally lit up and there is no isolated ghost-lighting point. That is, the effect of eliminating isolated ghost-lighting points can be achieved and therefore the user's viewing experience is improved as a result.

By the following detailed description with reference to accompanying drawings, other aspects and features of the invention will become apparent. However, it should be understood that, the drawings only are for the purpose of explanation and not as limiting the scope of the invention, and the scope of the invention should refer to the appended claims. It also be appreciated that, unless otherwise indicated, the drawings are not necessarily drawn to scale, they are merely trying to conceptually illustrate the structures and procedures described herein.

### BRIEF DESCRIPTION OF THE DRAWINGS

FIG. 1 is a schematic partial circuit diagram of a LED display board of a conventional scanning-type LED display screen.

FIG. 2 is a schematic view of a conventional row scanning method.

FIG. 3 is a schematic view of a display effect in the situation of adopting the row scanning method as shown in FIG. 2.

FIG. 4 is a schematic view of a row scanning method according to an embodiment of the invention.

FIG. 5 is a schematic view of a display effect in the situation of adopting the row scanning method as shown in FIG. 4, according to an embodiment of the invention.

FIG. 6 is a schematic partial block diagram of a LED display screen system according to an embodiment of the invention.

FIG. 7 is a schematic partial block diagram of a LED display control card according to an embodiment of the invention.

### DETAILED DESCRIPTION OF EMBODIMENTS

In order to make the above objectives, features and advantages of the invention be more clear and readily understood, concrete embodiments of the invention will be described below in detail with reference to the accompanying drawings.

A scanning method proposed by an embodiment of the invention is a forward and reverse alternate scanning method, and specifically, during a first round of scanning, receiving a row selection signal and decoding the received row selection signal to sequentially scan n numbers of scan lines as per a first scanning order and thereby drive and control a plurality of LEDs electrically connected to the n numbers of scan lines, and during a second round of scanning, receiving another row selection signal and decoding the received another row selection signal to sequentially scan the n numbers of scan lines as per a second scanning order and thereby drive and control the plurality of LEDs electrically connected to the n numbers of LEDs. The first round of scanning and the second round of scanning are alternately performed, the first scanning order and the second scanning order are mutually reverse orders. Herein, it is indicated that, the terminology [Row] associated with [row selection signal] according to the invention only is an idiomatic expression in the art, it is not limited to the horizontal direction or the vertical direction.

To facilitate understanding, referring to FIG. 4, the forward and reverse alternate scanning method according to an embodiment of the invention is that: the first round of scanning is performed sequentially from the 1st line scan to the nth line scan (i.e., the last line scan), the second round of scanning is performed sequentially from the nth line scan to the 1st line scan, afterwards the third round of scanning is performed sequentially from the 1st line scan to the nth line scan, the fourth round of scanning is performed sequentially from the nth line scan to the 1st line scan, and so on.

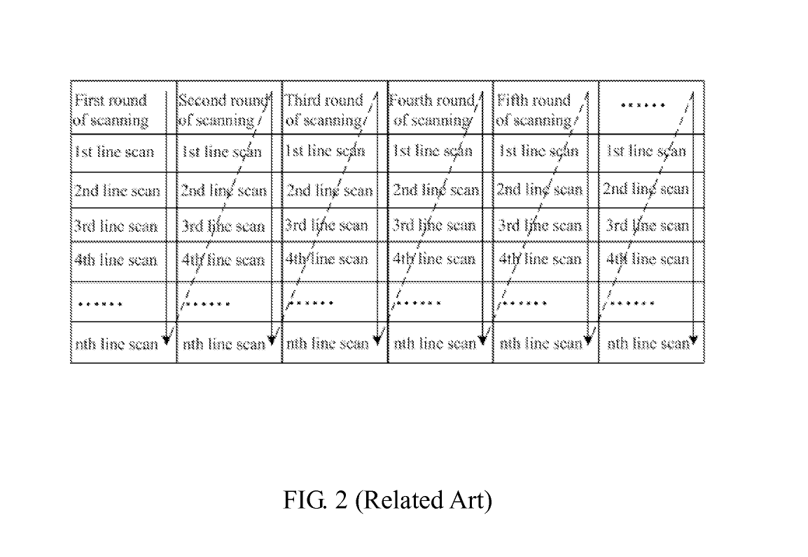

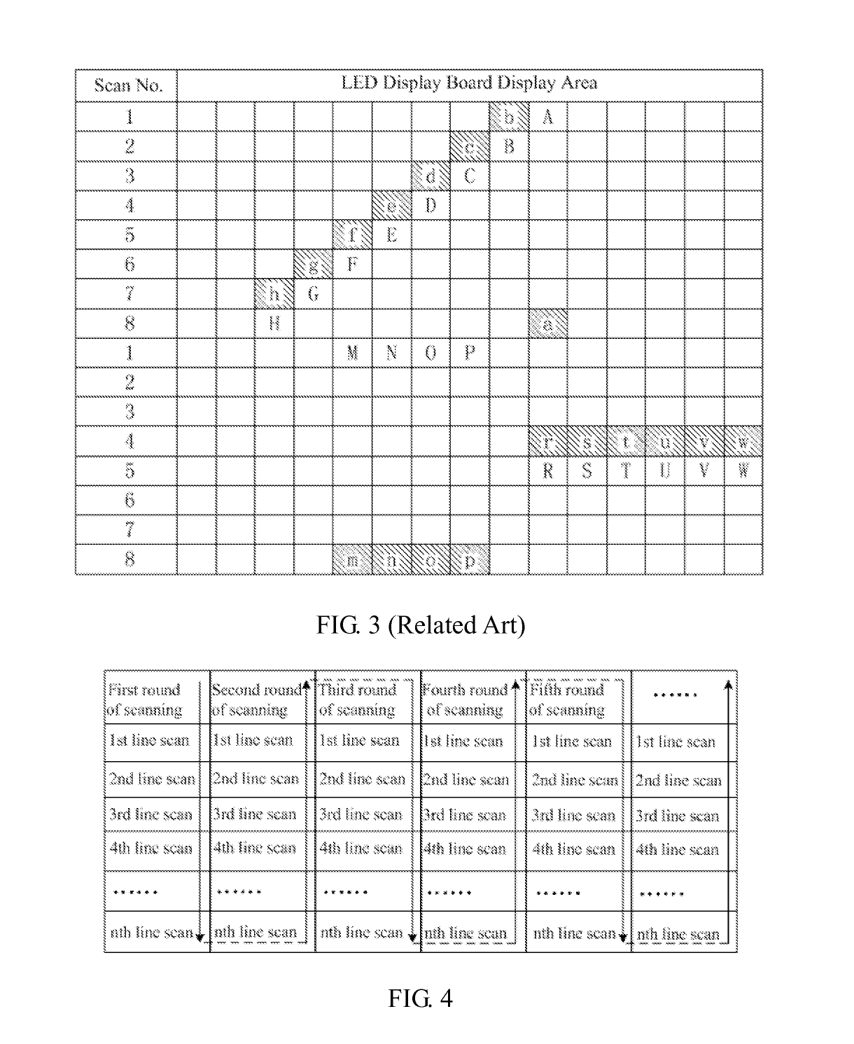

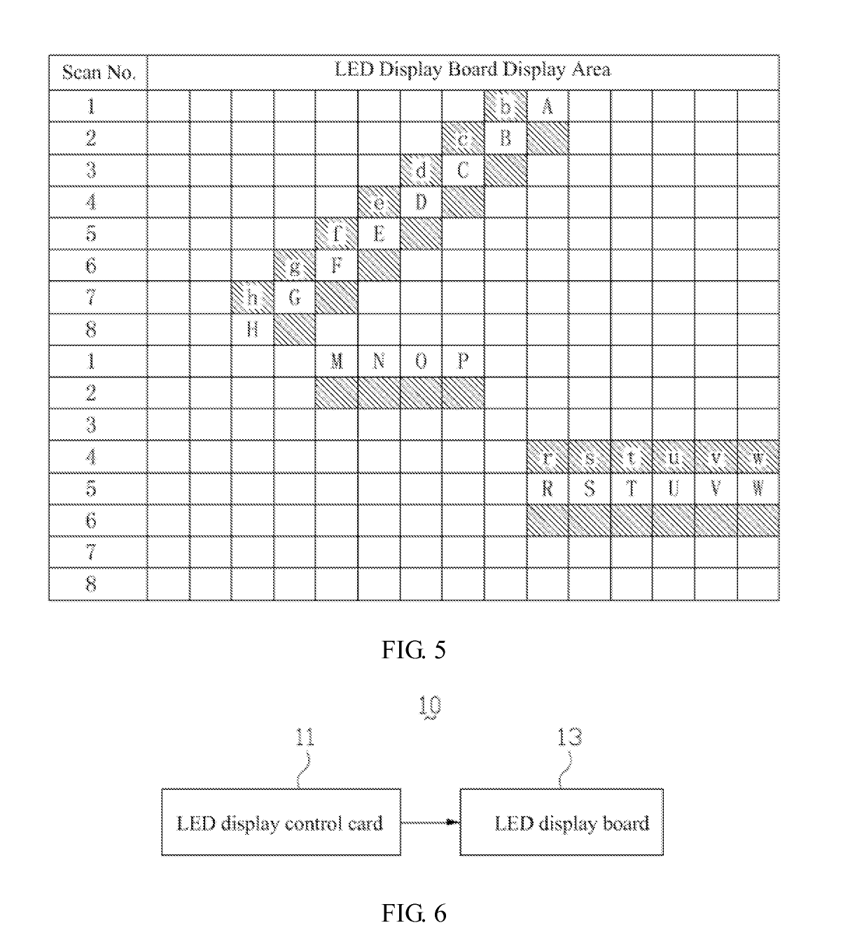

Referring to FIG. 5, as per the forward and reverse alternate scanning mode according to the embodiment of the invention, ghost-lighting points are expected to be distributed at positions of previous line scan and latter line scan of LEDs required to be normally lit up and there is no isolated ghost-lighting point. Compared FIG. 5 with FIG. 3, it can be found that, the conventional scanning method as illustrated by FIGS. 2 and 3 produces the isolated ghost-lighting points a, m, n, o and p, but the forward and reverse alternate scanning method according to the embodiment of the invention as illustrated by FIGS. 4 and 5 no longer produces any isolated ghost-lighting point and therefore the user's viewing experience can be effectively improved as a result.

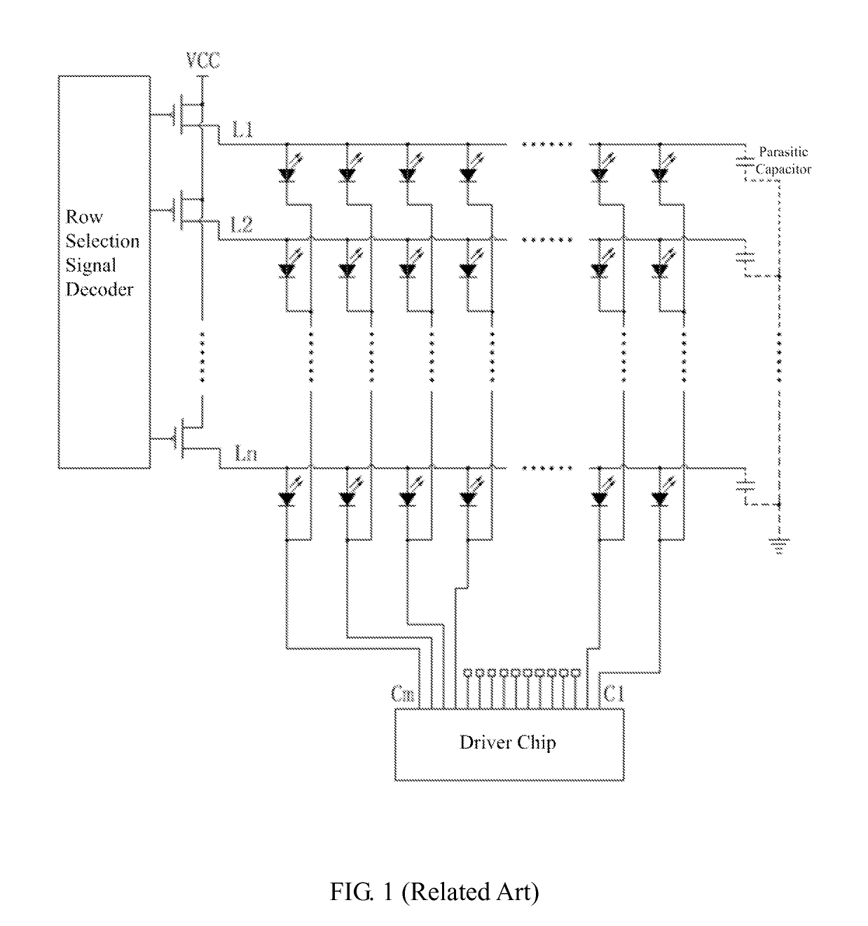

Referring to FIG. 6, a LED display screen system 10 according to an embodiment of the invention includes a LED display control card 11 and a LED display board 13. For a synchronous LED display screen system, the LED display control card 11 may be a receiving card or a combination of a receiving card and a front-end sending card. For an asynchronous LED display screen system, the LED display control card 11 may be an asynchronous control card. Moreover, the LED display board 13 may be a monochrome LED display board, a two-color LED display board or a full-color LED display board, and a number of the LED display board 13 may be one or multiple (i.e., more than one). A partial structure of one LED display board 13 can refer to FIG. 1, and the LED display board 13 for example includes a decoder for receiving a row selection signal and decoding the received row selection signal and a driver IC for receiving an image data signal to thereby realize grayscales of LEDs required to be lit up. In addition, the LED display control card 11 generally is disposed with a programmable logic device for example a FPGA (Field Programmable Gate Array) chip for receiving an image signal inputted from the front-end and performing an image data processing to thereby drive and control the LED display board 13. Of course, it can be understood that, in order to match with the forward and reverse alternate scanning method, a provision manner of image data from the programmable logic device to the LED display board 13 is required to make adaptability adjustment, i.e., it is needed to ensure that the currently provided image data is the image data required by the current line scan, so as to achieve a correct display.

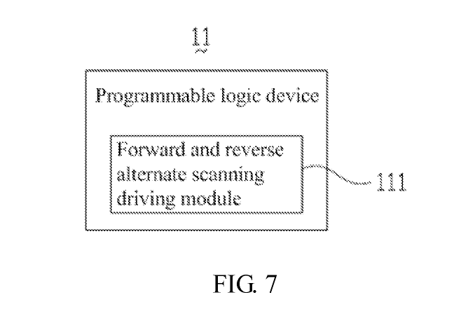

Referring to FIG. 7, the LED display control card 11 according to the present embodiment further is disposed with a forward and reverse alternate scanning driving module 111 integrated with the programmable logic device together, for example both are integrated into a same chip. For example, the forward and reverse alternate scanning driving module 111 according to the present embodiment is a software module stored in a non-volatile memory and executable by a FPGA chip to generate required row selection signal to the LED display board 13 and thereby control the LED display board 13 to sequentially scan n numbers of scan lines as per a first scanning order during a certain round of scanning and sequentially scan the n numbers of scan lines as per a second scanning order during the next round of scanning The first scanning order and the second scanning order are mutually reverse orders, for example, the first scanning order is from the 1st line scan to the nth scan while the second scanning order is from the nth line scan to the 1st line scan, and vice versa.

In the above embodiment of the invention, the row selection signal is a multi-bit digital signal, and when a 3-bit digital signal is taken as an example, a single round of scanning is a 8-line scan (i.e., n=8). When the row selection signal is “000”, the 1st line scan is performed; when the row selection signal is “001”, the 2nd line scan is performed; when the row selection signal is “010”, the 3rd line scan is performed; when the row selection signal is “011”, the 4th line scan is performed; when the row selection signal is “100”, the 5th line scan is performed; when the row selection signal is “101”, the 6th line scan is performed; when the row selection signal is “110”, the 7th line scan is performed; and when the row selection signal is “111”, the 8th line scan is performed. Of course, the row selection signal of the invention is not limited to the 3-bit digital signal, it can be a 2-bit digital signal, a 4-bit digital signal or other-bit digital signal, and correspondingly, a single round of scanning may be a 4-line scan, a 16-line scan or other-line scan.

It can be understood that, the forward and reverse alternate scanning driving module 111 according to the above-described embodiment of the invention is not limited to the software module, it can be embodied by a hardware structure instead, for example, regardless of which one round of scanning, when the row selection signal being a 3-bit digital signal still is taken as an example, the programmable logic device for example FPGA chip always sequentially generates the digital signal sequence of “000”, “001”, “010”, “011”, “100”, “101”, “110” and “111”, when the reverse scanning is required to be performed, a set of inverters in the forward and reverse alternate scanning driving module 111 perform logical negation operations to obtain the digital signal sequence of “111”, “110”, “101”, “100”, “011”, “010”, “001” and “000”, and in such way, the forward and reverse alternate scanning mode of the invention also can be realized.

As seen from the foregoing, the above embodiments of the invention propose the forward and reverse alternate scanning method, which can make that the ghost-lighting points are distributed at the positions of previous line scan and the latter line scan of LEDs required to be normally lit up and there is no isolated ghost-lighting point. That is, the beneficial effect of eliminating isolated ghost-lighting points can be achieved and therefore the user's viewing experience is improved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

The various embodiments of the invention propose a forward and reverse alternate scanning method, which can make that the ghost-lighting points are distributed at the positions of previous line scan and the latter line scan of LEDs required to be normally lit up and there is no isolated ghost-lighting point. That is, the beneficial effect of eliminating isolated ghost-lighting points can be achieved and therefore the user's viewing experience is improved.

What is claimed is:

1. A LED display control method adapted for being applied to a plurality of LEDs electrically connected with N numbers of scan lines, where N is a positive integer greater than 1; the LED display control method comprising:
during a first round of scanning, receiving a row selection signal and decoding the received row selection signal to sequentially scan the N numbers of scan lines as per a first scanning order and thereby drive and control the plurality of LEDs; and
during a second round of scanning, receiving another row selection signal and decoding the received another row selection signal to sequentially scan the N numbers of scan lines as per a second scanning order and thereby drive and control the plurality of LEDs;
wherein the first round of scanning and the second round of scanning are alternately performed, the first scanning order and the second scan order are mutually reverse orders.

2. The LED display control method as claimed in claim 1, wherein the row selection signal and the another row selection signal each are a multi-bit digital signal.

3. The LED display control method as claimed in claim 2, wherein the digital signal is a 2-bit digital signal, a 3-bit digital signal or a 4-bit digital signal.

4. A LED display screen system comprising a LED display control card and a LED display board electrically connected with the LED display control card, the LED display board being disposed with a decoder and a plurality of LEDs electrically connected to N numbers of scan lines, where N being a positive integer greater than 1; wherein:
the LED display control card is disposed with a forward and reverse alternate scanning driving module, and the forward and reverse alternate scanning driving module is configured for:
during a first round of scanning, generating a row selection signal to the decoder and thereby the decoder decoding the row selection signal to sequentially scan the N numbers of scan lines as per a first scanning order so as to drive and control the plurality of LEDs; and
during a second round of scanning, generating another row selection signal to the decoder and thereby the decoder decoding the another row selection signal to sequentially scan the N numbers of scan lines as per a second scanning order so as to drive and control the plurality of LEDs;
the first round of scanning and the second round of scanning being alternately performed, the first scanning order and the second scanning order being mutually reverse orders.

5. The LED display screen system as claimed in claim 4, wherein the row selection signal and the another row selection signal each are a multi-bit digital signal.

6. The LED display screen system as claimed in claim 4, wherein the LED display control card further is disposed with a programmable logic device; the forward and reverse alternate scanning driving module and the programmable logic device are integrated into a same chip.

7. A LED display control card adapted for receiving an image signal and processing the received image signal to drive and control a LED display board, the LED display board being disposed with a plurality of LEDs electrically connected to N numbers of scan lines, where N is a positive integer greater than 1; wherein the LED display control card further is disposed with a forward and reverse alternate scanning driving module, and the forward and reverse alternate scanning driving module is configured for:
during a first round of scanning, generating a row selection signal to the LED display board to thereby control the LED display board to sequentially scan the N numbers of scan lines as per a first scanning order so as to drive and control the plurality of LEDs; and
during a second round of scanning, generating another row selection signal to the LED display board to thereby control the LED display board to sequentially scan the N numbers of scan lines as per a second scanning order so as to drive and control the plurality of LEDs;
the first round of scanning and the second round of scanning being alternately performed, the first scanning order and the second scanning order being mutually reverse orders.

8. The LED display control card as claimed in claim 7, wherein the row selection signal and the another row selection signal each are a multi-bit digital signal.

9. The LED display control card as claimed in claim 7, wherein the LED display control card is a receiving card or an asynchronous control card.

10. The LED display control card as claimed in claim 7, wherein the LED display control card further is disposed with a programmable logic device; the forward and reverse alternate scanning driving module and the programmable logic device are integrated into a same chip.
